(19) United States
(12) Patent Application Publication
(10) Pub. No.: US 2016/0119461 A1
(43) Pub. Date: Apr. 28, 2016

(54) WEARABLE ELECTRONIC DEVICE AND TELEPHONE APPARATUS USING THE SAME

(71) Applicants: SHENG-LIAN LIN, Taoyuan County (TW); YU-YING LIN, Taoyuan County (TW); TUNG-YI LIN, Taoyuan County (TW)

(72) Inventors: SHENG-LIAN LIN, Taoyuan County (TW); YU-YING LIN, Taoyuan County (TW); TUNG-YI LIN, Taoyuan County (TW)

(21) Appl. No.: 14/586,068

(22) Filed: Dec. 30, 2014

(30) Foreign Application Priority Data
Oct. 23, 2014 (TW) 103136706

(51) Int. Cl. H04M 1/725; H04B 1/3827; H04W 4/00

(52) U.S. Cl. CPC H04M 1/7253; H04W 4/008; H04B 1/385

(57) ABSTRACT

A wearable electronic device performs a voice communication through a host. The wearable electronic device includes a wireless transmission module, an identification module and a voice transceiver module. The wireless transmission module is configured to transmit signals with the host. The identification module is stored with a prepaid amount data provided to the host for a validation, and the wearable electronic device builds up a voice communication through the host when the validation is positive. The voice transceiver module is electrically connected to the wireless transmission module. A telephone apparatus using the aforementioned wearable electronic device is also provided.

### FIELD OF THE INVENTION

The present invention generally relates to an electronic device, and more particularly to a wearable electronic device and a telephone apparatus using the same.

### BACKGROUND OF THE INVENTION

With the popularity of cell phones, the number of public telephone device has significantly decreased, and it is not convenient for a user to carry coins or prepaid phone card.

However, with the increasing size of cell phone resulted by being equipped with increasing size of display screen and increasing number of functions, it is not convenient for a user to carry a large-sized cell phone always. Especially, for those using the cell phone for phone calls only, not only money but also resources are wasted.

### SUMMARY OF THE INVENTION

One aspect of the present invention is to provide a wearable electronic device configured to perform a voice communication through a host.

Another aspect of the present invention is to provide a telephone apparatus capable of building up a voice communication by connecting a host and a wearable electronic device therein.

The present invention provides a wearable electronic device configured to perform a voice communication through a host. The wearable electronic device includes a wireless transmission module, an identification module and a voice transceiver module. The wireless transmission module is configured to transmit signals with the host. The identification module is stored with a prepaid amount data provided to the host for a validation, wherein the wearable electronic device builds up a voice communication through the host when the validation is positive. The voice transceiver module is electrically connected to the wireless transmission module.

In one embodiment, the identification module includes a radio frequency identification tag or a barcode label.

In one embodiment, the wireless transmission module is a Bluetooth module, an ANT module, a ZigBee module, a near-field communication module, an ultra-wideband module, a TransferJet module, an infrared communication module or a Li-Fi module.

In one embodiment, the voice transceiver module includes a microphone and a speaker.

In one embodiment, the wearable electronic device further includes a radio module configured to receive an incoming phone call signal.

In one embodiment, the wearable electronic device is a wireless headset.

The present invention further provides a telephone apparatus includes a host and a wearable electronic device. The host is connected to a communication network and includes a communication module, a validation module, a control unit and a display panel, wherein the control unit is electrically connected to the communication module, the validation module and the display panel. The wearable electronic device is configured to perform a voice communication through the host. The wearable electronic device includes a wireless transmission module, an identification module and a voice transceiver module. The wireless transmission module is configured to transmit signals with the communication module of the host. The identification module is stored with a prepaid amount provided to the validation module for a validation. The voice transceiver module is electrically connected to the wireless transmission module, wherein the wearable electronic device builds up a voice communication through the host when the validation is positive.

In one embodiment, the identification module includes a radio frequency identification tag or a barcode label.

In one embodiment, the wireless transmission module is a Bluetooth module, an ANT module, a ZigBee module, a near-field communication module, an ultra-wideband module, a TransferJet module, an infrared communication module or a Li-Fi module.

In one embodiment, the voice transceiver module includes a microphone and a speaker.

In one embodiment, the wearable electronic device further includes a radio module configured to receive an incoming phone call signal.

In one embodiment, the wearable electronic device is a wireless headset.

In one embodiment, the display panel is a touch panel.

In one embodiment, the host is an interactive multimedia terminal (KIOSK).

In one embodiment, the validation module is a radio frequency identification module or a barcode scanning module.

In summary, through connecting a wearable electronic device to a host and validating prepaid amount data stored in an identification module of the wearable electronic device via a validation module of the host, a user can build up a voice communication through the wearable electronic device and the host of the present invention. Because the host can be implemented with an interactive multimedia terminal which is commonly set in convenience stores, the problem of not easy for finding traditional public telephones is solved. Moreover, compared with the mobile phones, the wearable electronic device has a smaller size and accordingly it is easier and more convenient for a user to carry the wearable electronic device. Furthermore, because certain amount money is prepaid and the related data is stored in the wearable electronic device, a user can make a phone call through the wearable electronic device and the host without preparing coins or prepaid phone card in advance.

### BRIEF DESCRIPTION OF THE DRAWINGS

Other advantages, objectives and features of the present invention will become apparent from the following description referring to the attached drawings.

FIG. 1 is a perspective schematic view of a telephone apparatus according to an embodiment of the present invention; and

FIG. 2 is a block view of the telephone apparatus of FIG. 1 according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

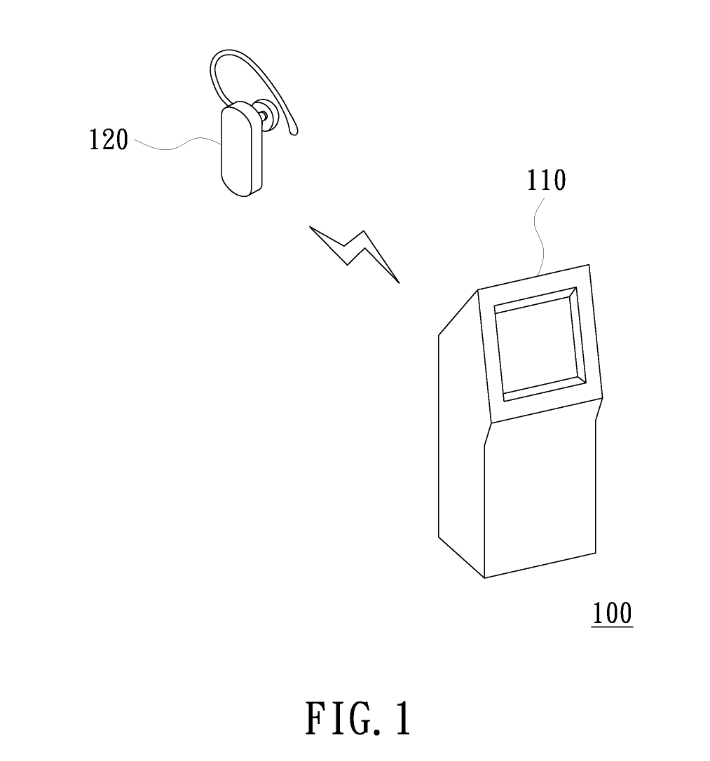

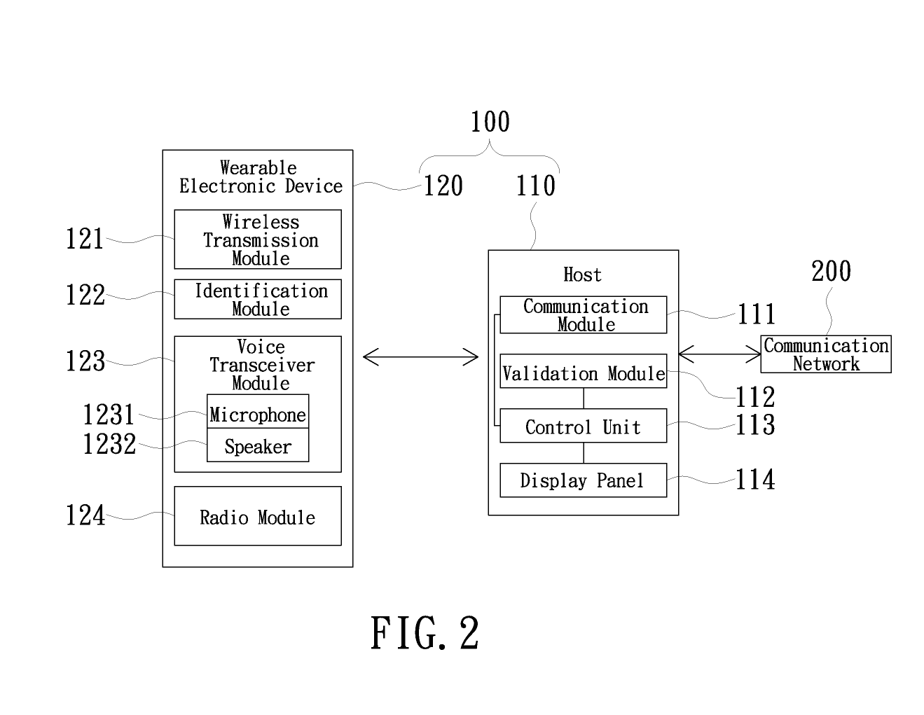

FIG. 1 is a perspective schematic view of a telephone apparatus in accordance with an embodiment of the present invention. FIG. 2 is a block view of the telephone apparatus of FIG. 1 in accordance with an embodiment of the present invention. Please refer to FIGS. 1 and 2. The telephone apparatus 100 in the present embodiment includes a host 110 and a wearable electronic device 120. The host 110 is connected to a communication network 200 in wired or wireless manner. The host 110 includes a communication module 111, a verification module 112, a control unit 113 and a display panel 114. The control unit 113 is electrically connected to the communication module 111, the verification module 112 and the display panel 114.

In one embodiment, the host 110 may be an interactive multimedia terminal (KIOSK), such as an ibon terminal, a Life-ET terminal or a FamiPort terminal which is commonly seen in convenience stores in Taiwan or an information terminal set in public areas. In another embodiment, the host 110 may be a computer or any other types of electronic devices connected to the communication network 200 via a variety of connection ways. Moreover, the communication module 111 and the wearable electronic device 120 can transmit signals with each other. The validation module 112 is configured to validate the wearable electronic device 120. The control unit 113 is configured to control the operations of the communication module 111, the verification module 112 and the display panel 114. In one embodiment, the display panel 114 is a touch panel, and accordingly a user can make a phone call by directly touching the touch display panel 114. Specifically, the display panel 114 may have a plurality of graphic interfaces, such as a call interface; and a user can make a phone call by clicking the call interface when the user tries to make a phone call through the host 110. In another embodiment, the host 110 may be equipped with a physical keyboard or a cursor control device for a user to click the call interface and input specific information if the display panel 114 is a non-touch panel.

As shown in FIG. 2, the wearable electronic device 120 is configured to build up a voice communication through the host 110. The wearable electronic device 120 includes a wireless transmission module 121, an identification module 122 and a voice transceiver module 123. The wearable electronic device 120 in FIG. 1 may be a wireless headset or any electronic device such as a smart watch; however, the present invention is not limited thereto. The communication module 111 of the host 110 and the personal wearable electronic device 120 can transmit signals with each other via the wireless transmission module 121. The wireless transmission module 121 may be a Bluetooth module, an ANT module, a ZigBee module, a near-field communication module, an ultra-wideband module, a TransferJet module, an infrared communication module or a Li-Fi module; however, the present invention is not limited thereto. The communication module 111 and the wireless transmission module 121 corporately use a compatible wireless signal transmission technology, so that the communication module 111 and the wireless transmission module 121 can transmit signals with each other and build up a connection.

In one embodiment, the identification module 122 may be stored with prepaid amount data for the host 110 to validate. The identification module 122 includes a radio frequency identification tag or a barcode label; however, the present invention is not limited thereto. Correspondingly, the validation module 112 of the host 110 includes specific components for validating the identification module 122. For example, if the identification module 122 includes a radio frequency identification tag, correspondingly the validation module 112 includes a radio frequency identification module for validating the radio frequency identification tag; and if the identification module 122 includes a barcode label, correspondingly the validation module 112 includes a barcode scanning module for validating the barcode label.

In this embodiment, the voice transceiver module 123 includes, for instance, a microphone 1231 and a speaker 1232. The voice transceiver module 123 is electrically connected to the wireless transmission module 121, through which the voice transceiver module 123 can transmit voice signals. The wearable electronic device 120 can build up a voice communication with the host 110 through the wireless transmission module 121 if the aforementioned validation is positive, so that a user can generate and receive voice signals through the microphone 1231 and the speaker 1232, respectively.

In one embodiment, when trying to perform a voice communication by using the wearable electronic device 120, a user may click the call interface displayed on the display panel 114 of the host 110 and move the wearable electronic device 120 to a specific position where the validation module 112 of the host 110 can validate the identification module 122 of the wearable electronic device 120. When the aforementioned validation is positive, the wearable electronic device 120 builds up a voice communication through the host 110. In one embodiment, the display panel 114 displays, through a control of the control unit 113, a dial-up interface for a user to dialup so that a user can perform a voice communication through the voice transceiver module 123 of the wearable electronic device 120.

For the dial fraud prevention, in one embodiment a login interface for asking a user to enter authentication information may be displayed on the display panel 114 before the dial up once the aforementioned validation is positive. The aforementioned authentication information may be user's ID and password or user's password only, and the present invention is not limited thereto.

Alternatively, if the aforementioned validation is negative (for example, the prepaid amount is insufficient), the control unit 113 may display fail validation information on the display panel 114 and accordingly the user cannot build up a voice communication through the host 110.

In one embodiment, to equip the wearable electronic device 120 with a function for receiving incoming phone calls, the wearable electronic device 120 may further include a radio module 124 for receiving an incoming phone call signal. In addition, the wearable electronic device 120 may be further configured to issue an alert sound to remind a user when the radio module 124 receives the incoming phone call signal which indicates that there is an incoming phone call, and the user can reply the incoming phone call in time. In another embodiment, the information about the incoming phone call may be displayed by a display panel when the wearable electronic device 120 is equipped with the display panel.

In summary, through connecting a wearable electronic device to a host and validating prepaid amount data stored in an identification module of the wearable electronic device via a validation module of the host, a user can build up a voice communication through the wearable electronic device and the host of the present invention. Because certain amount money is prepaid and the related data is stored in the wearable electronic device, a user can make a phone call through the wearable electronic device and the host instead of preparing coins or prepaid phone card in advance. In addition, because the host can be implemented with an interactive multimedia terminal which is commonly set in convenience stores, the problem of not easy for finding traditional public telephones is solved. Moreover, compared with the public telephones, the wearable electronic device is relatively clean and accordingly it is easier to reduce the risk of disease distribution. Furthermore, compared with the mobile phones, the wearable electronic device has a smaller size and accordingly it is easier and more convenient for a user to carry the wearable electronic device. In addition, compared with the mobile phones, the wearable electronic device has relatively simple functions so more power can be saved, the cost-of-production is down and the problems of resource waste is avoided.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A wearable electronic device configured to perform a voice communication through a host, the wearable electronic device comprising:
a wireless transmission module, configured to transmit signals with the host;
an identification module stored with a prepaid amount data provided to the host for a validation, wherein the wearable electronic device builds up a voice communication through the host when the validation is positive, wherein the identification module comprises a barcode label; and
a voice transceiver module, electrically connected to the wireless transmission module.

2. (canceled)

3. The wearable electronic device according to claim 1, wherein the wireless transmission module is an ANT module, a ZigBee module, a near-field communication module, or a TransferJet module.

4. The wearable electronic device according to claim 1, wherein the voice transceiver module comprises a microphone and a speaker.

5. The wearable electronic device according to claim 1, further comprising a radio module configured to receive an incoming phone call signal.

6. The wearable electronic device according to claim 1, wherein the wearable electronic device is a wireless headset.

7. A telephone apparatus, comprising:
a host, connected to a communication network, the host comprising:
a communication module;
a validation module;
a control unit; and
a display panel,
wherein the control unit is electrically connected to the communication module, the validation module and the display panel; and
a wearable electronic device, configured to perform a voice communication through the host, the wearable electronic device comprising:
a wireless transmission module, configured to transmit signals with the communication module of the host;
an identification module, stored with a prepaid amount provided to the validation module for a validate, wherein the identification module comprises a barcode label; and
a voice transceiver module, electrically connected to the wireless transmission module;
wherein the wearable electronic device builds up a voice communication through the host when the validation is positive.

8. (canceled)

9. The telephone apparatus according to claim 7, wherein the wireless transmission module is an ANT module, a ZigBee module, a near-field communication module, or a TransferJet module.

10. The telephone apparatus according to claim 7, wherein the voice transceiver module comprises a microphone and a speaker.

11. The telephone apparatus according to claim 7, wherein the wearable electronic device further comprises a radio module configured to receive an incoming phone call signal.

12. The telephone apparatus according to claim 7, wherein the wearable electronic device is a wireless headset.

13. The telephone apparatus according to claim 7, wherein the display panel is a touch panel.

14. The telephone apparatus according to claim 7, wherein the host is a KIOSK.

15. The telephone apparatus according to claim 7, wherein the validation module is a barcode scanning module.
